(19) United States
(12) Patent Application Publication
(10) Pub. No.: US 2001/0051995 A1
(43) Pub. Date: Dec. 13, 2001

(54) SYSTEM FOR OBTAINING DATA RELATED TO MULTIMEDIA CARRIERS

(76) Inventors: REINDER HAAKMA, EINDHOVEN (NL); JAN H ELENBAAS, NEW YORK, NY (US); K P LEE, YORKTOWN, NY (US)

Correspondence Address: CORPORATE PATENT COUNSEL, U S PHILLIPS CORP, 580 WHITE PLAINS ROAD, TARRYTOWN, NY, 10591

(21) Appl. No.: 09/090,007

(22) Filed: Jun. 2, 1998

(51) Int. Cl. G06F 15/16

(52) U.S. Cl. 709/217

(57) ABSTRACT

The invention relates to a system for managing data related to multimedia carriers, such as CDs. The system comprises a player which maintains a local database containing data related to multimedia carriers in a collection. After inserting a multimedia carrier, the player identifies it and searches the local database for data related to the multimedia carrier. If no data is found, the player contacts a central database in order to download data related to the multimedia carrier and store it in the local database.

### FIELD OF THE INVENTION

The invention relates to a system for obtaining data related to multimedia carriers comprising an apparatus for playing multimedia carriers, which apparatus comprises storage means for storing data related to the multimedia carriers and identification means for determining an identification of a respective one of the multimedia carriers. An example of an apparatus for playing multimedia carriers is a CD/DVD-player or a video cassette recorder (VCR).

The invention further relates to an apparatus for playing multimedia carriers, which apparatus comprises storage means for storing data related to the multimedia carriers and identification means for determining an identification of a respective one of the multimedia carriers.

The invention further relates to a database server comprising storage means for storing data related to multimedia carriers.

### BACKGROUND OF THE INVENTION

A CD player is known which comprises storage means for storing a database of playlists of a collection of audio-CDs. This database is used by the ‘favourite track selection’ (FTS) system. The CD player comprises identification means for uniquely identifying a CD, e.g. by its UPC code (see IEC Compact disc digital audio system 1987). After entering a play-list for a CD, a user of the known CD player has the option to store the play-list permanently in the storage means. In that case, the CD player reads the UPC code from the CD and stores it together with the play-list. After entering the same CD a next time, the user can obtain the play-list from the FTS memory automatically. In that case the CD player reads the UPC code from the CD and uses it as a key to find the play list in the FTS memory. The user needs to enter favourite tracks from a large number of CDs only once, and there is no need to identify the CD each time before storing or retrieving the playlist.

### OBJECT AND SUMMARY OF THE INVENTION

It is an object of the invention to provide further options for obtaining data related to a collection of multimedia carriers. To achieve that object, the system according to the invention is characterized in that the system further comprises a database server which is connectable to the apparatus, the apparatus further comprising communication means for uploading the identification of the respective multimedia carrier to the database server, the database server being adapted to use said identification as a database key for finding data related to the respective multimedia carrier and send the data to the apparatus. In the system according to the invention the storage means contain a local database of data related to the multimedia carrier, which data could comprise track names, names of artists, lyrics etc. After inserting a multimedia carrier, the apparatus identifies it and searches the local database for data related to the multimedia carrier. If the local database does not contain any data related to the multimedia carrier, the apparatus contacts a central database by means of the communication means, e.g. via a telephone network. The identification of the multimedia carrier is used as a key to search the central database. If the central database contains data related to the multimedia carrier, the data are downloaded into the local database of the apparatus, evading the need to enter these data manually. If the central database does not contain the data, other remote databases could be contacted.

In a further embodiment, the apparatus for playing multimedia carriers according to the invention is characterized in that the apparatus further comprises presentation means for presenting the data in the storage means on a display screen. The display screen could be a part of the apparatus, or the apparatus could have an interface to a distinct further apparatus comprising a display screen. In an advantageous embodiment this further apparatus is a television receiver, which is widely available. Preferably, the apparatus comprises interaction means for browsing through the local database and selecting data related to a particular multimedia carrier, which is further referred to as the selected multimedia carrier. If the presentation means present data related to only one multimedia carrier at a time, said multimedia carrier could be considered the selected multimedia carrier. Otherwise, selecting a multimedia carrier could be achieved by highlighting data or by any other well known method. The interaction means could enable a user to find multimedia carriers using various search criteria, such as genre, mood, artist etc., which criteria can be composed by menu selections using, for example, a remote control.

Multimedia carriers can be identified in various ways. In a preferred embodiment the multimedia carrier contains a code which uniquely identifies the carrier, such as the UPC code of optical discs. Alternatively, a signature can be generated, e.g. by computing a checksum of a predetermined part of the data contained by the carrier in a predetermined way. A code could also be furnished by the publisher and entered manually by the user, e.g. in the case of a prerecorded video cassette where computing a checksum might be problematic. In that case the identification means are merely input means for entering the identification code.

In a preferred embodiment the apparatus has an automatic mode, in which mode data related to a multimedia carrier is download automatically if the local database does not contain such data. In a further embodiment this mode can be disabled to avoid automatic downloading of data about every multimedia carrier which is inserted into the apparatus, e.g. when the multimedia carrier is not a permanent member of the user's collection.

The system according to the invention is particular convenient for optical disc players, but is could be also applied to video cassettes etc. Even data related to books in a book collection could be obtained using a system according to the invention, the apparatus not so much ‘playing’ the book but merely managing the local database. In a more advanced embodiment, playing a book could mean reading the book to the user by means of an automatic text-to-speech system.

These and other aspects of the invention will be apparent from and elucidated with reference to the embodiments described hereinafter.

### BRIEF DESCRIPTION OF THE DRAWINGS

FIG. 1 shows a diagram of a system according to the invention,

FIG. 2 shows a diagram of an apparatus according to the invention.

### DESCRIPTION OF EMBODIMENTS

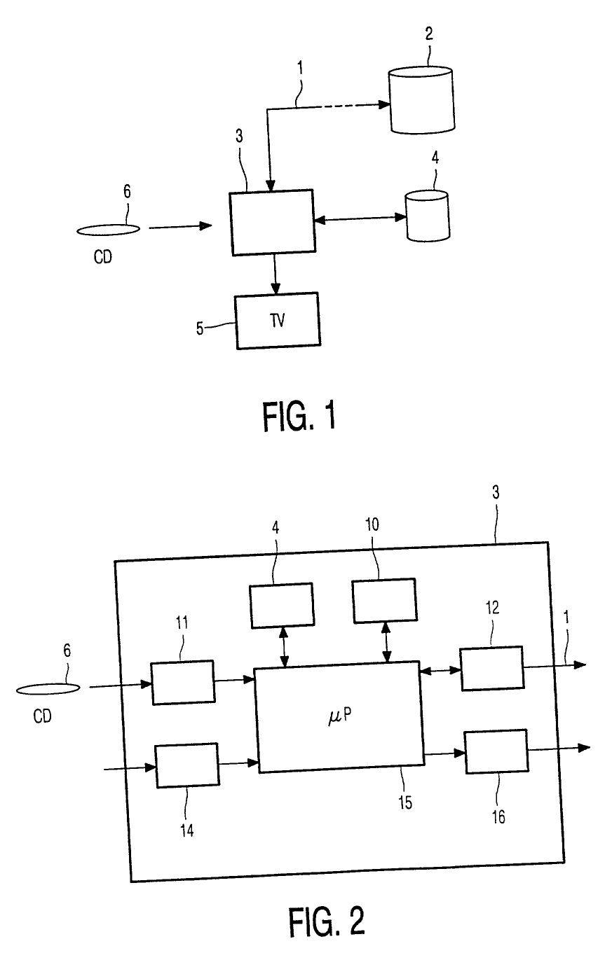

FIG. 1 shows a diagram of a system according to the invention, comprising a CD player 3 as an apparatus for playing multimedia carriers. It can be connected to a central database server 2 via a cable network 1. De CD player 3 comprises or has access to storage means 4 and is connected to a television receiver 5. The storage means 4 contain a local database of data related to CDs, which data comprise track names, names of artists, lyrics etc. After inserting a CD 6, the CD player 3 identifies the CD 6 by reading its UPC code and searches the local database in the storage means 4 for data related to the CD 6. If the local database does not contain any data related to the CD 6, the apparatus contacts the central database server 2. The UPC code of the CD 6 is used as a key to search the central database. If the central database contains data related to the CD 6, the data are downloaded into the storage means 4 via the cable network 1. A next time the same CD 6 is inserted into the CD player 3, the data related to the CD 6 is already in the local database, hence need not be downloaded again from the central database server 2. In this way the system according to the invention provides an easy way of obtaining information about the CDs in one's CD collection. Each time a new CD is purchased, inserting the new CD into the CD player 3 suffices to acquire useful information about the new CD. Optionally, this function can be turned off to avoid automatic downloading of information about a CD which is not a permanent member of the CD collection. The address of the central database server is stored in a non-volatile memory (not shown) in the CD player 3. Optionally, addresses of multiple database servers could be stored, and the user could be enabled to add or remove addresses from this list.

The data in the storage means 4 can be inspected by a user via the television receiver 5. Browsing through the data is possible with a remote control (not shown) of the CD player 3, e.g. by simply traversing the list of CDs using up/down buttons, or more advanced using various search criteria, such as genre, mood, artist etc., which criteria can be composed by menu selections. These menu selections can be accomplished in various well known ways, e.g. using up/down buttons and a confirmation button.

Instead of being connectable to the television receiver 5 the CD player 3 could comprise display means itself for presenting the data in the storage means 4. Also a combination of these two options could be applied.

FIG. 2 shows a diagram of a CD player as an example of the apparatus according to the invention. The CD player 3 comprises the storage means 4, identification means 10, playing means 11, communication means 12, interaction means 14, a micro processor 15 and presentation means 16. The micro processor 15 communicates with said other parts of the CD player 3. When a CD 6 is inserted into the playing means 11, it is identified by de identification means 10 by reading the UPC code. The code is used as a key to search in the storage means 4 for data related to the CD 6. If such data are found in the storage means 4, they are presented on the display screen of the television receiver 5, by means of the presentation means 16 which constitute an interface to the television receiver 5. The data can be browsed through by means of the interaction means 14. If no data related to the CD 6 are found in the storage means 4, the communication means 12 contact a database server and the UPC code is transmitted as a key for searching said data in the database of the database server. If the data is found at the database server, the data is transmitted to the CD player 3. The communication means 12 are adapted to receive the data from the cable network 1 and store the data in the storage means 4. The data downloaded this way becomes part of the local database and can be browsed through by means of the interaction means 14 and the presentation means 16. Beside textual data also pictures of CD covers and short sound samples could be stored in the database to further enhance the search facilities. In an alternative embodiment the data is not stored locally, but downloaded each time the data is needed. This has the advantage that the storage means 4 could have a lower capacity, because only a list of the identities of the CDs in the collection need to be stored. Even this list could be stored at a central database server, which could be accessed by means of a unique customer identification. However, such approaches have the disadvantage that acceptable access and response times cannot always be guaranteed.

If the data comprises information which is likely to be updated from time to time, e.g. ratings or reviews, the CD player could be further adapted to check regularly whether the data in the local database is still up to date.

In principal, all data related to any CD in one's collection could be obtained by downloading from a central database server. However, in practice not every CD will be available from central databases, e.g. when the CD has only regional significance or when the CD is recorded at home. Therefore the CD player could be extended with input means (not shown) to enter the data into the CD player. These input means could be combined with the interaction means 14, e.g. on a remote control.

Summarizing, the invention relates to a system for managing data related to multimedia carriers, such as CDs. The system comprises a player which maintains a local database containing data related to multimedia carriers in a collection. After inserting a multimedia carrier, the player identifies it and searches the local database for data related to the multimedia carrier. If no data is found, the player contacts a central database in order to download data related to the multimedia carrier and store it in the local database.

1. A system for obtaining data related to multimedia carriers comprising an (apparatus for playing multimedia carriers, which apparatus comprises storage means for storing data related to the multimedia carriers and identification means for determining an identification of a respective one of the multimedia carriers, characterized in that the system further comprises a database server which is connectable to the apparatus, the apparatus further comprising communication means for uploading the identification of the respective multimedia carrier to the database server, the database server being adapted to use said identification as a database key for finding data related to the respective multimedia carier and send the data to the apparatus:

2. An apparatus for playing multimedia carriers, which apparatus comprises storage means for storing data related to the multimedia carriers and identification means for determining an identification of a respective one of the multimedia carriers, characterized in that the apparatus further comprises communication means for uploading the identification of the respective multimedia carrier to a remote database server and downloading data related to the respective multimedia carrier from the remote database server.

3. An apparatus according to claim 2, characterized in that the apparatus further comprises presentation means for presenting the data in the storage means on a display screen.

4. An apparatus according to claim 3, characterized in that the apparatus further comprises interaction means for browsing through the data in the storage means.

5. An apparatus according to claim 4, characterized in that the interaction means are further adapted to select data related to a selected multimedia carrier.

6. An apparatus according to any of the claims 2 to 5, the multimedia carriers comprising an identification code, characterized in that the identification means being adapted to read the identification code and the apparatus being adapted to relay the identification code to the remote database server.

7. An apparatus according to any of the claims 2 to 5, characterized in that the identification means are adapted to identify a multimedia carrier comprising multimedia information by computing a signature of at least a part of the multimedia information, the apparatus being adapted to relay the signature to the remote database server.

8. An apparatus according to any of the claims 2 to 7, characterized in that the apparatus has an automatic mode, in which mode the apparatus is adapted to download data related to the respective multimedia carrier automatically, upon identifying said carrier, if the storage means do not contain data related to said carrier.

9. An apparatus according to claim 8, characterized in that the apparatus further comprises a control enabling a user to disable the automatic mode.

10. A database server comprising storage means for storing data related to multimedia carriers, characterized in that the database server is adapted to receive an identification of a respective one of the multimedia carriers from a client and use said identification as a database key for finding data related to the respective multimedia carrier and send the data to the client.
